(19) United States
(12) Patent Application Publication
(10) Pub. No.: US 2008/0152768 A1
(43) Pub. Date: Jun. 26, 2008

(54) Disposable cup containing dry beverage food or medicament ingredients in liquid permeable bag heat welded to its inner surface

(76) Inventors: Sheng-Chung Lan, Taichung (TW); Eric McClure, Trabuco Canyon, CA (US)

Correspondence Address: MARY HELEN SEARS AND M.H.SEARS LAW FIRM CHARTERED, 2801 NEW MEXICO AVE, N.W., APT.1004, WASHINGTON, DC, 20007, US

(21) Appl. No.: 11/643,865

(22) Filed: Dec. 22, 2006

(51) Int. Cl. A23B 4/10

(52) U.S. Cl. 426/125

(57) ABSTRACT

A new and convenient article of commerce is comprised of a disposable cup having permanently vacuum heat-welded to the bottom thereof a small bag fashioned from woven, non-woven, or knitted natural plant fibers, or from woven or knitted synthetic fibers, which small bag contains dried tea leaves, soluble coffee or cocoa or any other dry beverage or beverage mix, a dried or dehydrated food such as a soup mix or a dried medicament such as dried antibacterial mouthwash, aspirin or other analgesic or antacid.

The bag is fashioned with a seam along one side and at least a small portion or spot of that seam line is vacuum welded at a temperature between 100° C. and 200° C. and a frequency of about 20,000 kilohertz to the bottom of the cup form a permanent bond. When hot or cold liquid is added to the cup, the bag containing the desired dry beverage precursor, dry food precursor, or dried medicament floats freely from the spit at which it is welded so that the circulating liquid passes through the bag and becomes thoroughly mixed with the contents of the bag to produce the desired beverage, food (especially soup) or diluted medicament which is easily drunk or otherwise consumed from the cup. The used cup and its content may then be quickly and easily discarded.

The present invention is a new article of commerce in the form of a disposable paper cup having a liquid permeable bag or pouch made from woven, non-woven or knitted natural fibers of plant origin, or from a woven or knitted synthetic fabric which has been ultrasonically fused at least at one small spot of its periphery to the bottom of the cup, wherein the bag or pouch contains tea leaves, soluble coffee or cocoa or another finely divided, dehydrated food or beverage or medicament formulation in soluble form. The food, beverage or medicament is reconstituted with a soluble liquid and the cup including the bag or pouch and any residue of consumption may be discarded readily.

### BACKGROUND OF THE INVENTION

Various disposable cups containing soluble coffee, soup or cereal mixes, etc. have been described in the art. See, for example the cup described in U.S. Pat. No. 4,134,492 wherein a disposable cup is described that has a deposit in its inner bottom in form of a layer of soluble coffee, dehydrated soup or dry cereal to which hot or cold water, milk or other liquid may be added after manual removal of a plastic liner that covers the coffee or other deposit in the cup bottom and has been vacuum formed to line the interior walls of the cup and extend over the rim whereof, to which it is sealed, thereby maintaining its interior germ free during handling and storage. Other cups having a similar purpose are shown in various patents referred to in said patent.

It has also heretofore been conventional to package soluble coffee, cocoa and other powdered and otherwise dehydrated soup and beverage mixes and the like in paper packets constructed of materials that are essentially liquid impermeable so that they will not deteriorate under normal conditions of shelf storage and handling.

The use of tea bags, which are normally fashioned of non-woven natural plant fibers, to contain tea leaves, which bags may be placed in china or earthenware cups into which hot or boiling water can be poured to make tea in situ is of long standing duration, but similar bags have not heretofore found much favor in the packaging of soluble coffee, cocoa and other powdered or dehydrated soup and beverage mixes. Even in the case of tea leaf packaging, the highest quality of gourmet teas have often not found their way into tea bags, because of the strongly held belief of many tea fanciers that a better cup of tea has been achieved when boiling water is poured over a carefully measured amount of tea per desired cup of beverage and allowed to steep for a predetermined time before pouring into cups.

The time pressures of modern life, however, have resulted in consumer demand that teas of every variety, including those of highest quality, be made available in tea bags because the availability of tea bags in lieu of loose tea speeds the tea-making process and the cleanup of tea making and allows many people who would not otherwise have the time to enjoy a morning and/or afternoon cup of tea of any variety that may be personally preferred.

Availability in small permeable tea bag-type-pouches permanently anchored by ultrasonic “welding” to a paper cup bottom of dry ingredients needed to make not only tea but other beverages and/or soups by merely adding appropriate liquid of a desired temperature is expected to be a great convenience to countless workers in offices, assembly plants, laboratories and other workplaces.

### BRIEF DESCRIPTION OF THE DRAWING

FIG. 1. hereof depicts a cross-section of the interior of a cup according to this invention containing a water permeable bag in turn containing dry beverage—or soup making ingredients which bag has been ultrasonically heat welded (or heat-fused) to the bottom of a cup.

### DESCRIPTION OF THE INVENTION

The following definitions apply herein:

(1) “Heat-welded”, “heat-fused”, “spot-fused” and “spot-welded” are all terms used herein interchangeably to denote the permanent ultrasonic heat bonding of at least a small portion, in the order of about 2-4 square millimeters of a liquid-permeable bag or pouch to the bottom of a common paper cup. It should be understood that up to about ½ of the periphery (and hence of the surface area) of the liquid-permeable surface of the “tea bag” may be so fused to the bottom of the cup without departing from this invention.

(2) The terms “tea bag” and “liquid-permeable bag or pouch” are used interchangeably herein to mean any liquid permeable bag made from knitted, woven or non-woven natural plant fibers, or knitted or woven synthetic fibers, or both. In general non-woven natural plant fibers such as cotton, flax, bagasse, etc. which have been conventionally converted into fused fibrous, non-woven sheets that are semipermeable to air and freely liquid permeable are the preferred materials for the bags and pouches used in this invention. Knitted and woven natural and synthetic fibers, while fusible to paper cups, are more permeable to air and any contaminants it may carry than non-woven natural fibers and their use may cause earlier deterioration of the dry ingredients in the bags than would occur with non-woven natural fiber bags as well as allowing possible contamination thereof and/or possible deterioration of the flavor of dried ingredients. Synthetic non-woven fibers become essentially air and water impermeable plastic sheets when it is attempted to fuse them into sheets. The sheets, while readily heat fusible to cups, are unsuitable for packaging in a cup beverages and soups intended to be reconstituted in the same cup by simply adding water (or another liquid) to that cup, because of their impermeability.

In some instances woven or knitted natural or synthetic fiber bags and pouches may be adequate materials for packaging dried beverage, food, or medicament materials and may be used in this invention. Thus, for example, if the paper cups used are provided with lids for shipping and storage purposes, the packaging of many dry ingredients in woven or knitted natural or synthetic fiber bags within each cup may be wholly adequate in most instances. Even when the paper cups are to remain unlidded during shipping and storage, the dry ingredients within the bag or pouch may not require the enhanced preservative effect afforded by encasing them in non-woven natural fiber bags.

(3) The term “finished cup” wherever used herein refers to a lidless paper cup to the bottom of which a liquid-permeable bag or pouch containing a dried or dehydrated beverage, food or medicament precursor has been permanently heat fused.

(4) The term “medicament” as used herein; includes mouth washes (some of which are currently available in powdered form) as well as aspirin and other analgesics and any other medicinal material in dried form that is soluble in water or other liquid.

The present invention takes advantage of the recognition that ultrasonic high vacuum heat sealing of at least a small portion of the periphery of a liquid permeable “tea bag” to the inner bottom of an ordinary paper cup enables the cup to be used, wherever water (or any other liquid compatible with the contents of the tea bag) is available, as the receptacle for making a refreshing beverage and the receptacle from which to drink the beverage, whereupon the cup may conveniently be thrown away with no need for wasted time or motion of any nature, including clean-up.

In developing a finished tea cup according to this invention, attention has been given to the fact that some people, in attempting to make tea very quickly using either loose tea or a tea bag have been inclined to add more loose tea than recommended or to put in not one but two or three bags per cup of tea desired in an effort to speed up the tea making process. The result—often called “overbrewing”—is a tea that, at minimum, is too strong and in the worst case may be undrinkable because of its overly strong flavor. The tea bags employed in the finished cups of this invention have been carefully prepared to contain a measured amount of dry tea leaves for preparing a cup of tea commensurate with the size of the cup, which cup of tea exhibits optimum flavor when prepared as either hot or iced tea. Due to the carefully measured amount of tea placed in the tea bag, moreover, the tea in each finished cup also cannot become “overbrewed” by being left in contact with the water for an extended time.

Development of this invention, in the first instance, proceeded using bagged high quality green teas, especially those of Chinese origin. During early work, it was thought that the bag should advantageously be anchored to the cup bottom along a seam of the tea bag, thereby maintaining it firmly at the bottom of the cup; however it was then discovered that the flavor of the highest quality teas was not up to the flavor obtained with the sample teas when a tea bag was placed in a cup and swirled around in the water while the tea was being made. This experience led to the recognition that the spot welding of a tiny area of the tea bag preferably in the order of about 2-4 square centimeters, to the bottom of the paper cup allows the bulk of the tea-bag to float freely in water and thus enables the water to swirl through the tea leaves in the bag and contact them thoroughly so that the resulting tea is of desired optimum flavor.

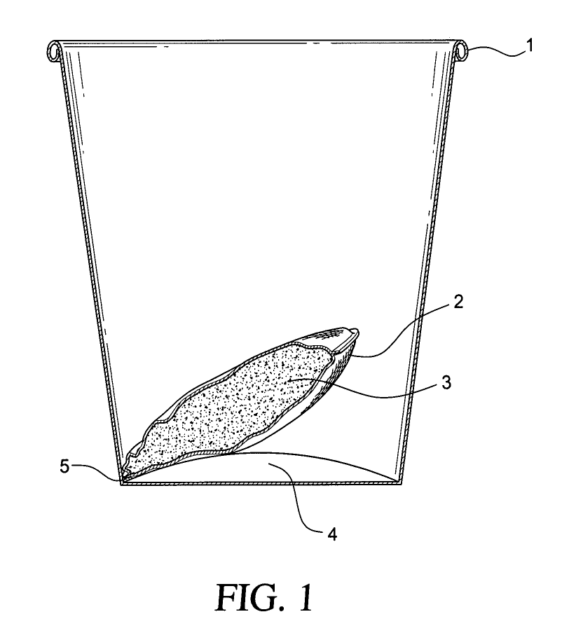

Turning to FIG. 1, it depicts a cross-sectional view of a typical finished cup according to this invention wherein a tea-filled tea bag has been spot welded to a point at the junction of the side and bottom of the cup designated as point 5. In this drawing, the numeral 1 identifies the upper rim of the disposable paper cup, 2 identifies the tea bag and 3 points to the tea leaves contained in the bag, while point 4 denotes the bottom of the cup. Addition of water (not shown) to the cup has caused the liquid-permeable tea bag to intake water and to inflate and appear to be buoyed up and to float in the circulating water in a more or less upward direction except at its anchor point 5 where the tea bag has previously been permanently fused to the cup by the acoustic ultrasonic heat sealer. The fact that the bond to the cup bottom at point 5 is a strong one is a boon to the cup user in that it permits easy and non-messy disposal of cup and attached tea bag when the tea has been finished.

To insure that the water can optimally penetrate the tea bag and contact the tea leaves fully, thereby assuring the brewed tea is of a quality commensurate with that of the tea leaves in the tea bag, it is important that the bonding of the tea bag to the bottom of the paper cup be confined to a small spot on the bag, having a surface area of only a very few square centimeters, in the order of 2-4. This “spot” area is not a number critical to the performance of the invention; rather, what is critical is that the spot be of a size small enough that the bulk of the tea bag is not impeded from lifting off the cup bottom and appearing to float above that bottom when water is added to fill the cup. When this floating effect occurs the water is able to circulate and flow freely through the tea leaves so as to effectively produce a brewed tea of a quality commensurate with that of the tea leaves in the bag within a reasonable time.

While the cup and tea bag unit has been discussed herein with particular reference to the addition of hot water to make hot tea, it is contemplated that cold water, with or without ice cubes, can be added to the cup assembly of this invention if cool or iced tea is desired. Addition of milk, sugar, lemon and other flavoring to the finished tea can be made if desired. Also it is within the scope of this invention to add, e.g. powdered or dried flavorings to the tea leaves before closing the tea bag and spot-fusing it to the bottom of a cup. With some of the dried or powdered “mix” ingredients that can be loaded into “tea bag” pouches and similarly made available in a disposable paper cup, such as soups and various cold beverage mixes, it may be desirable to enlarge the length or the overall area of the tea bag that is spot-fused and such enlargement is within the scope of this invention.

The beverage, soup and medicament cups of this invention are made by moving common paper cups disposed at spaced intervals in spaced apertures of a rapidly moving belt sequentially to a first station at which one tea bag containing tea leaves or a dry or dehydrated precursor of another beverage or a soup or medicament is downloaded into the center of each cup from a suitable automatic dispenser.

Each cup then is sequentially moved by the belt to an ultrasonic acoustic heat-sealing device operated at a frequency of about 20,000 kilohertz. The temperature used for fusing the tea bag to the cup bottom ranges between about 100° and about 200° C. depending upon the thickness of the paper cup and the thickness and composition of the membrane used in making the tea bag.

Utilizing paper cups of medium weight and tea bags of unwoven natural cotton, linen or bagasse, applicants presently employ a temperature of about 150° C.±5° in making the disposable finished cup of this invention.

It is noted that medicines of various types and antibacterial mouthwash ingredients can be powdered and packaged in “tea bag” pouches, which can be ultrasonically welded to the bottom of a disposable paper cup as herein described. For example, an ordinary antacid or aspirin product in dry powdered form in a “tea bag” that is heat welded to the bottom of a paper cup would enable a person to medicate an acid reflex reaction or a headache at any location where running water is available. Many other uses for paper cups containing dried or dehydrated beverage, food or medicament precursors in tea bag-like pouches that are spot-welded ultrasonically to the cup bottom will be readily apparent and all will greatly enhance the convenience of modern life.

The finished cups containing a dried or dehydrated precursor of a beverage, a foodstuff (e.g. soup) or a medicament can be equipped with lids or left unlidded. If they are to be lidded, the lids are applied while the cups move along the assembly belt at a lid-dispensing station that is positioned after the acoustic ultrasonic heat-sealing device. It is anticipated that lidded cups will be able to be stored for longer periods without deterioration of the beverage, food or medicament ingredients stored within their heat welded pouches. However, in many instances it will be convenient and desirable to leave the finished cups unlidded and to pack them in stacks of 10, 20 or more units which are then boxed so that they can be downloaded into handy cup dispensers in cafeterias, hospitals, manufacturing plants and other areas where people will find then convenient for immediate use followed by immediate disposal.

Because the present invention is versatile and presents the possibility of many individually distinct embodiments, it is intended that the scope thereof be limited only by the appended claims:

We claim:

1. As a new article of commerce, a disposable paper cup having heat fused to the inner bottom thereof a small bag fashioned from non-woven, woven or knitted natural plant fibers or from woven or knitted synthetic fibers, which small bag contains a beverage, food or medicament precursor in dried form.

2. A disposable paper cup according to claim 1 wherein said small bag has been fused to the inner cup bottom at a temperature between 100° C. and about 200° C. and at a frequency of about 20,000 kilohertz.

3. A disposable paper cup according to claim 2 wherein said small bag is fashioned from non-woven natural fiber and has been fused to the inner cup bottom at a temperature between about 145° C. and 155° C.

4. A disposable paper cup according to claim 3 in which said small bag contains dried tea leaves.

5. A disposable paper cup according to claim 3 in which said small bag contains dry soluble coffee.

6. A disposable paper cup according to claim 3 in which said small bag contains dry soluble cocoa or hot chocolate.

7. A disposable paper cup according to claim 3 in which said small bag contains dry solid beverage mix having a sweetened or unsweetened fruit flavor upon being reconstituted with a suitable liquid.

8. A disposable paper cup according to claim 3 in which said small bag contains dry solid soup mix.

9. A disposable paper cup according to claim 3 in which said small bag contains dry a food precursor other than a soup mix.

10. A disposable paper cup according to claim in which said small bag contains a dry solid medicinal substance or mixture of medicinal substances.

11. A disposable paper cup according to claim 10 in which said small bag contains a dry antibacterial mouthwash material.

12. A disposable paper cup according to claim 10 in which said small bag contains aspirin or another analgesic or an antacid product, in powder form.
